(19) United States
(12) Patent Application Publication
(10) Pub. No.: US 2004/0122173 A1
(43) Pub. Date: Jun. 24, 2004

(54) Hydrolytically stable polymer dispersions and methods of making the same

(76) Inventor: Kyu-Jun Kim, Chapel Hill, NC (US)

Correspondence Address: MYERS BIGEL SIBLEY & SAJOVEC, PO BOX 37428, RALEIGH, NC, 27627, US

(21) Appl. No.: 10/328,124

(22) Filed: Dec. 23, 2002

(51) Int. Cl. C08L 67/08

(52) U.S. Cl. 525/167.5

(57) ABSTRACT

A core/shell polymer composition with ester linkages formed from secondary or tertiary hydroxy groups may be used with a dispersion agent to form water dispersible polymer compositions for inks, curable coatings, paints, and the like.

### FIELD OF THE INVENTION

This invention relates to resins used in the coatings and paint industries, more particularly, this invention relates to compositions of hydrolytically stable alkyd dispersions that may be used in the coatings and paint industries.

### BACKGROUND OF THE INVENTION

Environmental concerns over the use of volatile organic compounds have sparked tighter regulations regarding their use in the coatings and paint industries. In an attempt to reduce the use of volatile organic compounds in the coating and paint industries, other compositions, such as water dispersible compositions, are being considered.

Alkyd compositions have been widely used in the coatings and paint industries to provide desirable characteristics for coating and paint mixtures. The use of alkyd compositions in coatings and paints provides, among other things, corrosion resistance and blocking resistance for surfaces to which the coating or paint containing the alkyd composition is applied. The alkyd compositions may also affect the gloss characteristics of the coating or paint applied.

In light of environmental concerns, water-reducible alkyds have been developed and used as alternatives to the conventional alkyd. The use of water-reducible alkyds in the coatings and paint industries, however, has been limited by the short shelf life of such compositions. The shelf life of water-reducible alkyd compositions used in the coatings and paint industries is dependent, in part, upon the integrity of ester linkages within the alkyd compositions. The ester linkages in the water-reducible alkyd compositions are prone to hydrolysis. Hydrolysis of the ester linkages in a water-reducible alkyd lowers the molecular weight of the water reducible alkyd composition and hinders the performance of the coating or paint.

A number of methods and compositions have been developed in an attempt to improve the stability and shelf life of water-reducible alkyd compositions. For instance, core/shell alkyds have been developed wherein acrylic monomers are grafted to fatty acids and the formed acrylic grafted fatty acids are reacted with hydroxyl terminated alkyds prepared with excess of primary hydroxy functional groups. The acrylic monomers act as a shell for the alkyd core. The hydrolysis-prone core alkyd developed in this manner is partially protected from water, and hydrolysis, by the shell acrylic monomer.

The core/shell alkyd compositions provide some protection from hydrolysis for the primary ester linkages of the core alkyds. However, the primary ester linkages of the core/shell alkyds are not immune to hydrolysis and such compositions tend to break down over time due to hydrolysis of the primary ester linkages. Therefore, it would be beneficial to develop a water dispersible polymer composition usable in the coatings and paint industries that may slow the effects of hydrolysis and provide compositions having a longer shelf life or useable life.

### SUMMARY OF THE INVENTION

Various embodiments of the present invention relate to resins used in coating compositions, paint compositions, and other water dispersible compositions. More particularly, embodiments of the present invention relate to water dispersible polymer compositions including core polymers and shell polymers. In some embodiments of the present invention, the water dispersible polymer compositions exhibit improved storage life over conventional water dispersible polymer compositions due to decreased hydrolysis of the core polymer of the water dispersible polymer. Hydrolysis of the core polymer may be reduced according to some embodiments of the present invention by forming core polymers having ester linkages formed from secondary or tertiary hydroxy groups.

A water dispersible polymer according to some embodiments of the present invention includes a core polymer and a shell polymer. The core polymer may include an ester linkage originating from fatty acid in the shell polymer. The core polymer may include ester linkages formed from secondary or tertiary hydroxy groups. The shell polymer may be formed by the radical polymerization of one or more ethylenically unsaturated monomers and (meth)acrylic acid in the presence of unsaturated fatty acids. The core polymer and shell polymer may be combined by condensation reaction.

In other embodiments of the present invention, a water dispersible polymer composition includes a core polymer having ester linkages formed from secondary or tertiary hydroxy groups and a shell polymer, wherein the core polymer constitutes at least 10 weight percent of the water dispersible polymer composition. The shell polymer of these embodiments may be formed by the radical polymerization of one or more ethylenically unsaturated monomers and (meth)acrylic acid in the presence of unsaturated fatty acids. The core polymer and shell polymer may be combined by condensation reaction.

According to some embodiments of the present invention a water dispersible polymer composition includes a core polymer and a shell polymer wherein the shell polymer is formed in the presence of the core polymer. For instance, the shell polymer may be formed by direct radical polymerization of one or more ethylenically unsaturated monomers and (meth)acrylic acid into the core polymer. In this case, the core polymer may not include an ester linkage originating from fatty acid in the shell polymer. The core polymer may include ester linkages formed from secondary or tertiary hydroxy groups. In some embodiments, at least 5 molar percent of the ester linkages in the core polymer are formed by ester linkages of secondary or tertiary hydroxy groups.

In other embodiments of the present invention, a water dispersible polymer composition is used to form a coating or paint composition. The water dispersible polymer composition includes a core polymer having ester linkages formed from secondary or tertiary hydroxy groups combined with a shell polymer. The shell polymer may include a shell polymer formed by the radical polymerization of one or more ethylenically unsaturated monomers and (meth)acrylic acid in the presence of unsaturated fatty acids and combined with the core polymer by a condensation reaction. Alternatively, the shell polymer may be formed by direct radical polymerization of one or more ethylenically unsaturated monomers and (meth)acrylic acid into the core polymer. The water dispersible polymer composition may be combined with additives to form a desired coating or paint composition. For example, a paint composition may be formed by combining the water dispersible composition according to embodiments of the invention with pigments, water and other additives.

### DETAILED DESCRIPTION OF THE INVENTION

The present invention now will be described more fully hereinafter. This invention may, however, be embodied in many different forms and should not be construed as limited to the embodiments set forth herein; rather, these embodiments are provided so that this disclosure will be thorough and complete, and will fully convey the scope of the invention to those skilled in the art.

The present invention relates to resins used in, for example, coating compositions, paint compositions, and other water dispersible compositions. More particularly, embodiments of the present invention relate to water dispersible polymer compositions including core polymers and shell polymers wherein the core polymers of the water dispersible polymer compositions include secondary or tertiary hydroxy ester linkages. For instance, various embodiments of the present invention comprise core/shell polymer dispersions wherein the core polymer includes ester linkages formed from secondary or tertiary hydroxy groups.

Hydrolysis of ester linkages in core polymers of core/shell polymer dispersions decreases the stability of the core/shell polymer dispersion. Hydrolysis occurs when water from a dispersion reacts with the ester linkage of the core polymer. The hydrolysis of ester linkages in a core polymer destabilizes the core/shell polymer dispersion and detracts from the dispersion's coating performance. Thus, reduced or slowed hydrolysis of ester linkages in core/shell polymers may improve the performance of the core/shell polymers in water dispersible polymer compositions, such as paints and coatings.

Ester linkages in the core polymers according to various embodiments of the present invention are formed from the reaction of carboxylic acids with secondary or tertiary hydroxy groups. These linkages are different than the primary ester linkages of conventional water dispersible polymer compositions, which are formed from the reaction of carboxylic acids with primary hydroxy groups. Formation of an ester linkage using the secondary or tertiary hydroxy groups of a core polymer protects the core polymer from hydrolysis. The protection of a secondary or tertiary hydroxy ester linkage in a core polymer may result from steric hindrance, or the presence of hydrophobic hydrocarbons that may help keep water away from the ester linkage. Consequently, hydrolysis of the ester linkages of the core polymers in the water dispersible polymer compositions according to the present invention are reduced or slowed, resulting in improved water dispersible polymer compositions having longer shelf lives and improved stability.

According to embodiments of the present invention, a water dispersible polymer composition comprises a core polymer and a shell polymer, wherein the core polymer includes secondary and/or tertiary hydroxy ester linkages. The core polymer may include an ester linkage originating from fatty acid in the shell polymer. The water dispersible polymer composition according to these embodiments may comprise between about 10 weight percent and about 90 weight percent of a core polymer and between about 90 weight percent and about 10 weight percent of a shell polymer.

In various embodiments of the present invention, a water dispersible polymer composition comprises a core/shell polymer composition having secondary and/or tertiary hydroxy ester linkages formed from the combination of a core polymer with a shell polymer. To form the water dispersible polymer composition, a precursor of core polymer may be prepared and combined with a precursor of shell polymer. The precursor of core polymer may be prepared with excess hydroxy groups, wherein at least a portion of the hydroxy groups include secondary or tertiary hydroxy groups. A precursor of shell polymer, to be combined with a precursor of core polymer, may be prepared by radical polymerization of at least one ethylenically unsaturated monomer and (meth)acrylic acid in the presence of unsaturated fatty acids. Combination of the core polymers and shell polymers may be accomplished through a condensation reaction. Alternatively, a shell polymer may be formed by radical polymerization of the at least one ethylenically unsaturated monomer and (meth)acrylic acid in the presence of the core polymer such that a condensation reaction to combine the core polymer and shell polymer is unnecessary. In this case, the core polymer may not include the ester linkage originating from fatty acid in the shell polymer.

In some embodiments of the present invention, the core polymer is formed such that at least 5 molar percent of core polymer ester linkages are formed from secondary and/or tertiary hydroxy groups. In other embodiments, 15 molar percent or more of core polymer ester linkages are formed from secondary and/or tertiary hydroxy groups. The core polymer may be an alkyd polymer or a polyester.

Core polymers according to embodiments of the present invention may be formed from compounds comprising excess hydroxy groups, such as primary and/or secondary hydroxy-containing polyols. For instance, primary hydroxy-containing polyols such as trimethylol propane, pentaerythritol, di-pentaerythritol, trimethylol ethane, neopentyl glycol, ethylene glycol, 1,4-butanediol, 1,6-hexanediol, 1,4-cyclohexl dimethanol, diethylene glycol, triethylene glycol, and 2-methyl 1,3-propanediol may be used to form a core polymer. Secondary hydroxy-containing polyols that may be used to form core polymers according to embodiments of the present invention include, but are not limited to, 2,2,4-trimethyl-1,3-pentanediol, 2,2′-bis(4-hydrocycyclohexy) propane, propylene glycol, dipropylene glycol, glycerol, and sorbitol.

In other embodiments, polyacids may be used alone or in combination with other acid compounds to form a core polymer. Some examples of polyacids that may be used to form core polymers according to embodiments of the present invention include, but are not limited to, isophthalic acid, terephthalic acid, trimellitic anhydride, adipic acid, 1,4-cyclohexyl dicarboxylic acid, succinic anhydride, maleic acid, fumaric acid, succinic acid, azaleic acid, sebacic acid, methyl succinic anhydride, dodecenyl succinic anhydride, tetrahydrophthalic anhydride, hexahydrophthalic anhydride, and phthalic anhydride.

In other embodiments, the core polymer may be formed with mono-functional acids, such as saturated or unsaturated fatty acids. For example, one or more mono-functional acids, such as sunflower fatty acid, toll oil fatty acid, linseed oil fatty acid, safflower oil fatty acid, benzoic acid, dehydrated castor oil fatty acid, and soybean oil fatty acid, may be used to form the core polymer. If the core polymer is formed from a fatty acid and it is to be used with a water dispersible polymer composition in an air-drying application where ambient curing without additional crosslinkers is desired, at least a portion of the fatty acids may include unsaturated fatty acids. Oils with air-drying capabilities may be used in place of the fatty acids. Some examples of oils that may be used to form the core polymers include, but are not limited to, sunflower oil, tall oil, soybean oil, tung oil, dehydrated castor oil and safflower oil.

In some other embodiments of the present invention, the core polymer may be formed from an alkyl substituted epoxy compound and an alkyl substituted cyclic carbonate compound. Examples of alkyl substituted epoxy compounds that may be used to form the core polymer include, but are not limited to, glycidyl neodecanoate, diglycidyl ether of bisphenol A, diglycidyl ethers of bisphenol F, pentaerythriol polyglycidyl ether, sorbitol polyglycidyl ether, and propylene oxide. Examples of alkyl substituted cyclic carbonates that may be used to form a core polymer includes propylene carbonate and butylene carbonate.

Shell polymers, according to some embodiments of the present invention, may be formed separately from the core polymer and combined with the core polymer using a condensation reaction. The shell polymers may be formed by radical polymerization of at least one ethylenically unsaturated monomer and (meth)acrylic acid in the presence of unsaturated fatty acids. In some embodiments, the shell polymer comprises at most, 90 weight percent of an unsaturated fatty acid. Shell polymers formed according to these embodiments may be combined with a core polymer by a condensation reaction wherein a carboxy group in a fatty acid and hydroxy group in an alkyd are reacted by heating a mixture of the core and shell polymers. The condensation reaction results in a core/shell polymer dispersion that may be used with water dispersible polymer compositions.

In other embodiments of the present invention, shell polymers may be formed in the presence of the core polymer. In such embodiments, a shell polymer is formed by polymerization of one or more ethylenically unsaturated monomers and (meth)acrylic acid in the presence of a core polymer. The formation of the shell polymer in the presence of the core polymer produces a core/shell polymer dispersion that may be used with water dispersible polymer compositions.

Examples of ethylenically unsaturated monomers that may be used to form shell polymers according to embodiments of the present invention include, but are not limited to, styrene, vinyl toluene, methyl methacrylate, hydroxy ethyl acrylate, hydroxy ethyl methacrylate, hydroxy propyl acrylate, hydroxy propyl methacrylate, isobornyl methacrylate, n-butyl methacrylate, isobutyl methacrylate, n-butyl acrylate, and 2-ethyl hexyl (meth)acrylate. In those instances where the shell polymer is to be combined with a core polymer by a condensation reaction, the use of hydroxy functional (meth)acrylates may be limited to a level that avoids gellation of the core and shell polymers during a condensation reaction.

Examples of fatty acids that may be used to form shell polymers according to embodiments of the present invention include, but are not limited to, sunflower fatty acid, toll oil fatty acid, linseed oil fatty acid, safflower oil fatty acid, dehydrated castor oil fatty acid, and soybean oil fatty acid.

The formation of a shell polymer according to some embodiments of the present invention may also include the use of a radical initiator. Radical initiators that may be used to form the shell polymer include, but are not limited to, di-t-amyl peroxy cyclohexane, t-amyl peroxy-2-ethyl-hexanoate, t-butyl peroxy benzoate, di-t-butyl peroxide, t-butyl hydroperoxide, cumene hydroperoxide, and t-butyl peroctoate.

The core/shell polymer compositions formed according to some embodiments of the present invention may be thinned and/or neutralized to form dispersions that may be used with water dispersible polymer compositions. For example, core/shell polymer compositions formed from (meth)acrylic acid may be thinned with a hydrophilic organic solvent and neutralized with a neutralizing agent, such as an amine, in water to form a dispersion. The amount of organic solvent that may be used depends upon the desired application. However, for many water dispersible polymer compositions the amount of organic solvent in the water dispersible polymer composition may be between about 5 to about 30 weight percent based upon the weight of the resin solids in the water dispersible polymer composition. The amount of amine, or neutralizing agent, used to form the dispersion may be determined by the acid value of the dispersion and/or the desired pH of the dispersion. For instance, in many coating applications, a pH value of between about 7.0 and about 9.0 is desired. Therefore, a sufficient amount of neutralizing agent may be added to the dispersion to reach the desired pH value.

Organic solvents that may be used to thin the core/shell polymer compositions include, but are not limited to, butoxy ethanol, butoxy propanol, propoxy propanol, methoxy propanol, dipropylene glycol methylether, tripropylene glycol methylether, dipropylene glycol n-butyl ether, and t-butoxy propanol. Useful amines for neutralizing water dispersible polymer compositions include, but are not limited to, aqueous ammonia, triethyl amine, N,N-dimethyl ethanol amine, and N-methyl morpholine.

Water dispersible polymer compositions comprise core/shell polymer compositions according to embodiments of the present invention and other additives, such as thinners, neutralizers, pigments, water, or the like, which may be used to form dispersions for use in water dispersible polymer compositions. Water dispersible polymer compositions utilizing the core/shell polymers according to the present invention may be useful in inks, ambient temperature curing coatings, air-drying coatings, coatings requiring crosslinkers, such as melamine crosslinker coatings, baking coatings, and ambient curing coatings with multi-functional isocyanate crosslinkers.

Various Examples of core/shell polymer compositions, and water dispersible polymer compositions employing the same, according to embodiments of the present invention are described in Examples 1-9. Although the Examples provide details for forming specific core/shell polymer compositions according to embodiments of the present invention, it is understood that the Examples are not limiting. Example 10 is a comparative Example to which the polymer dispersion products of embodiments of the present invention from Examples 1-7 are compared in Table III.

### EXAMPLE 1

In this Example, a precursor of alkyd core polymer was synthesized with primary and secondary hydroxy polyols. To a flask were charged 130 parts of pentaerythritol, 370 parts of trimethyl pentanediol, 660 parts of Pamolyn 210, 330 parts of isophthalic acid, 3 parts of hypophosphorous acid, 50 parts of xylene and 0.5 parts of dibutyltin oxide. The flask was equipped with water receiver. Under nitrogen blanketing, the temperature was heated to 220-230° C. while removing water and xylene. The process continued until the acid value dropped below 5.0. The flask was cooled to 180° C. and 70 parts of glycidyl neodecanoate was charged to the flask. The process continued at 180° C. until the acid value dropped below 1.0.

A precursor of shell polymer was formed by the radical polymerization of ethylenically unsaturated monomers in the presence of fatty acid. A reactor equipped with a cold-water condenser was provided. To the reactor, 1099 parts of sunflower fatty acid, 715 parts of Pamolyn 210, 22 parts of di-t-butyl peroxide, 33 parts of styrene and 3.3 parts of hypophosphorous acid were charged. The reactor was heated to 150° C. under nitrogen atmosphere. At 150° C., a mixture of 514 parts of styrene, 824 parts of isobutyl methacrylate, 689 parts of methacrylic acid and 83 parts of di-t-butyl peroxide was fed into the reactor over a 4-hour time period. When the addition of the monomers was completed, 17 parts of di-t-butyl peroxide was charged over a 30-minute time period as a chaser. The process continued at 150° C. for additional 6 hours.

The two precursor polymers were combined to form a core/shell alkyd dispersion having secondary hydroxy ester linkages. To a reactor were added 500 parts of the synthesized precursor of core polymer and 584 parts of the precursor of shell polymer. The reactor was heated to 190-210° C. under nitrogen blanketing while collecting xylene and water. The process continued for 14 hours and the temperature was lowered to below 170° C. The product of the process was the core/shell alkyd. 539 parts of the product was transferred to a beaker for thinning. To the beaker was added 125 parts of n-butoxy propanol and the temperature was lowered to below 100° C. Under stirring, a mixture of 650 parts of de-ionized water and 40 parts of aqueous ammonia were charged into the beaker. The resulting water dispersion had an NV value of 38.1, a pH of 8.0, a viscosity of 48 Poise at 25° C., and an Acid Value of 30.4. The NV value is the percentage of the weight of sample after heating at 165° C. for 15 minutes divided by the weight of sample before heating.

### EXAMPLE 2

In this Example, a precursor of alkyd core polymer was synthesized with primary and secondary hydroxy polyols. To a flask equipped with a water receiver were charged 130 parts of pentaerythritol, 350 parts of trimethyl pentanediol, 150 parts of hydrogenated Bisphenol A, 660 parts of Pamolyn 210, 400 parts of isophthalic acid, 3 parts of hypophosphorous acid, 50 parts of xylene and 0.5 parts of dibutyltin oxide. Under nitrogen blanketing, the temperature was heated to 230° C. while removing water and xylene. The process continued until the acid value dropped below 15.0. The flask was cooled to 190° C. and 100 parts of glycidyl neodecanoate was charged to the flask. The process continued at 180° C. until acid value dropped below 3.0.

A precursor of shell polymer was formed by the radical polymerization of ethylenically unsaturated monomers in the presence of fatty acid. A reactor equipped with a cold-water condenser was provided. To the reactor, 1099 parts of sunflower fatty acid, 715 parts of Pamolyn 210, 22 parts of di-t-butyl peroxide, 33 parts of styrene and 3.3 parts of hypophosphorous acid were charged. The reactor was heated to 150° C. under nitrogen atmosphere. At 150° C., a mixture of 514 parts of styrene, 824 parts of isobutyl methacrylate, 689 parts of methacrylic acid and 83 parts of di-t-butyl peroxide was fed into the reactor over a 4-hour time period. When the addition of the monomers was completed, 17 parts of di-t-butyl peroxide was charged over a 30-minute time period as a chaser. The process continued at 150° C. for additional 6 hours.

A core/shell alkyd dispersion having secondary hydroxy ester linkages was formed from the two precursor polymers. To a reactor were charged 500 parts of a precursor of core polymer product and 584 parts of a precursor of shell polymer product. The reactor was heated to 210-220° C. under nitrogen blanketing while collecting xylene and water. The process continued for 9.5 hours and the temperature was lowered to below 170° C. The product of the process was the core/shell alkyd. To a beaker were transferred 504 parts of the core/shell alkyd for thinning. 150 parts of n-butoxy propanol was added to the beaker and the temperature was lowered to below 100° C. While stirring, a mixture of 640 parts of de-ionized water and 47 parts of aqueous ammonia was charged to the beaker. The resulting dispersion had an NV value of 35.1, a pH of 8.3, a viscosity of 24 Poise at 25° C., and an Acid Value of 29.9.

### EXAMPLE 3

In this Example, a precursor of alkyd core polymer was synthesized with primary and secondary hydroxy polyols. To a flask equipped with a water receiver were charged 120 parts of pentaerythritol, 40 parts of trimethyol propane, 900 parts of trimethyl pentanediol, 200 parts of sunflower fatty acid, 830 parts of isophthalic acid and 0.5 parts of dibutyltin oxide. Under nitrogen blanketing, the temperature was heated to 220-230° C. while removing water. The process continued until the acid value dropped below 12.0. The flask was cooled to 180° C. and 120 parts of glycidyl neodecanoate were charged to the flask. The process continued at 180° C. until acid value dropped below 1.0.

A precursor of shell polymer was formed by the radical polymerization of ethylenically unsaturated monomers in the presence of fatty acid. To a reactor equipped with a cold-water condenser were charged 700 parts of sunflower fatty acid, 715 parts of Pamolyn 210, 22 parts of di-t-butyl peroxide, 33 parts of styrene and 3.3 parts of hypophosphorous acid. The reactor was heated to 150° C. under nitrogen atmosphere. At 150° C., a mixture of 514 parts of styrene, 824 parts of isobutyl methacrylate, 516 parts of methacrylic acid and 83 parts of di-t-butyl peroxide were fed into the reactor over 4 hours. When the addition of the monomers was completed, 17 parts of di-t-butyl peroxide were charged over 30 minutes as a chaser. The process continued at 150° C. for an additional 3 hours.

A core/shell alkyd dispersion having secondary hydroxy ester linkages was prepared from the precursor polymers. To a reactor were charged 250 parts of a precursor of core polymer product, 350 parts of a precursor of shell polymer product, and 0.3 parts of dibutyltin oxide. The reactor was heated to 200° C. under nitrogen blanketing while collecting water. The process continued for 5 hours and the temperature was lowered to below 170° C. To the reactor were added 200 parts of butoxy ethanol and the temperature was lowered to below 100° C. While stirring, a mixture of 650 parts of de-ionized water and 35 parts of aqueous ammonia was charged into a flask. The resulting dispersion had an NV value of 39.0, a pH of 7.9, a viscosity of 80 Poise at 25° C., and an Acid Value of 30.0.

### EXAMPLE 4

In this Example, a precursor of alkyd core polymer was synthesized with primary and secondary hydroxy polyols. To a flask equipped with a water receiver were added 160 parts of pentaerythritol, 400 parts of trimethyl pentanediol, 270 parts of Hydrogenated Bisphenol A, 500 parts of sunflower fatty acid, 620 parts of isophthalic acid and 0.5 parts of dibutyltin oxide. Under nitrogen blanketing, the temperature was heated to 220-230° C. while removing water. The process continued until the acid value dropped below 10.0. The flask was cooled to 180° C. and 100 parts of glycidyl neodecanoate was charged to the flask. The process continued at 180° C. until the acid value dropped below 1.0.

A precursor of shell polymer was obtained by the radical polymerization of ethylenically unsaturated monomers in the presence of fatty acid. To a reactor equipped with a cold-water condenser were added 700 parts of sunflower fatty acid, 415 parts of Pamolyn 210, 22 parts of di-t-butyl peroxide, 33 parts of styrene and 3.3 parts of hypophosphorous acid. The reactor was heated to 150° C. under nitrogen atmosphere. At 150° C., a mixture of 514 parts of styrene, 824 parts of isobutyl methacrylate, 516 parts of methacrylic acid and 83 parts of di-t-butyl peroxide was fed into the reactor over a period of 4 hours. When the addition of the monomers was completed, 17 parts of di-t-butyl peroxide were charged over 1 hour as a chaser. The process continued at 150° C. for an additional 3 hours.

A core/shell alkyd dispersion having secondary hydroxy ester linkages was prepared from the precursor polymers. To a reactor were charged 250 parts of a precursor of core polymer product, 300 parts of a precursor of shell polymer product, and 0.3 parts of dibutyltin oxide. The reactor was heated to 200° C. under nitrogen blanketing while collecting water. The process continued for 7.5 hours and the temperature was lowered to below 170° C. To the reactor, 180 parts of butoxy ethanol was added and the temperature was lowered to below 100° C. While stirring, a mixture of de-ionized water and 30 parts of aqueous ammonia were charged to the reactor. The resulting dispersion had an NV value of 33.5, a pH of 8.0, a viscosity of 180 Poise at 25° C., and an Acid Value of 22.5.

### EXAMPLE 5

In this Example, a precursor of alkyd core polymer was synthesized with alkyl substituted epoxy. To a flask equipped with a water receiver were added 249 parts of pentaerythritol, 606 parts of Pamolyn 210, 195 parts of isophthalic acid, 8 parts of hypophosphorous acid and 0.5 parts of dibutyltin oxide. Under nitrogen blanketing, the temperature was heated to 210° C. while removing water. The process continued until the acid value dropped below 10.0. The flask was cooled to 160° C. and 630 parts of glycidyl neodecanoate and 0.5 parts of dibutyltin dilaurate were charged to the flask. The process continued at 160-180° C. until the NV (non-volatiles) reached over 96.0.

A precursor of shell polymer was obtained by the radical polymerization of ethylenically unsaturated monomers in the presence of fatty acid. To a reactor equipped with a cold-water condenser were added 880 parts of sunflower fatty acid, 400 parts of Pamolyn 210, 22 parts of di-t-butyl peroxide, 33 parts of styrene and 3.3 parts of hypophosphorous acid. The reactor was heated to 150° C. under nitrogen atmosphere. At 150° C., a mixture of 514 parts of styrene, 824 parts of isobutyl methacrylate, 789 parts of methacrylic acid and 94 parts of di-t-butyl peroxide were fed into the reactor over a period of 6 hours. The process continued at 150° C. for additional 2.5 hours.

A core/shell alkyd dispersion having secondary hydroxy ester linkages was prepared from the precursor polymers. To a reactor were charged 300 parts of a precursor of core polymer product and 240 parts of a precursor of shell polymer product. The reactor was heated to 190° C. under nitrogen blanketing while collecting water. The process continued for 2.5 hours and the temperature was lowered to below 170° C. To the reactor were added 86 parts of n-butoxy propanol and the temperature was lowered to below 100° C. While stirring, a mixture of 648 parts of de-ionized water and 54 parts of aqueous ammonia were charged to the reactor. The resulting dispersion had an NV value of 37.0, a pH of 8.0, a viscosity of 81 Poise at 25° C., and an Acid Value of 27.1.

### EXAMPLE 6

In this Example, a precursor of alkyd core polymer was synthesized with primary and secondary hydroxy polyols. To a flask equipped with a water receiver were added 185 parts of pentaerythritol, 280 parts of hydrogenated Bisphenol A, 606 parts of Pamolyn 210, 240 parts of isophthalic acid, 3 parts of hypophosphorous acid and 0.5 parts of dibutyltin oxide. Under nitrogen blanketing, the temperature was heated to 220° C. while removing water. The process continued until the acid value dropped below 5.0.

A precursor of shell polymer was formed by the radical polymerization of ethylenically unsaturated monomers in the presence of fatty acid. A reactor equipped with a cold-water condenser was provided. To the reactor, 1099 parts of sunflower fatty acid, 715 parts of Pamolyn 210, 22 parts of di-t-butyl peroxide, 33 parts of styrene and 3.3 parts of hypophosphorous acid were charged. The reactor was heated to 150° C. under nitrogen atmosphere. At 150° C., a mixture of 514 parts of styrene, 824 parts of isobutyl methacrylate, 689 parts of methacrylic acid and 83 parts of di-t-butyl peroxide was fed into the reactor over a 4-hour time period. When the addition of the monomers was completed, 17 parts of di-t-butyl peroxide was charged over a 30-minute time period as a chaser. The process continued at 150° C. for additional 6 hours.

A core/shell alkyd dispersion having secondary hydroxy ester linkages was prepared from the precursor polymers. To a reactor were charged 300 parts of a precursor of core polymer product and 353 parts of a precursor of shell polymer product. The reactor was heated to 190-200° C. under nitrogen blanketing while collecting water. The process continued for 13 hours and the temperature was lowered to below 170° C. To the reactor was added 120 parts of n-butoxy propanol and the temperature was lowered to below 100° C. While stirring, a mixture of 950 parts of de-ionized water and 38 parts of aqueous ammonia were charged to the reactor. The resulting dispersion had an NV value of 35.0, a pH of 7.8, a viscosity of 50 Poise at 25° C., and an Acid Value of 24.8.

### EXAMPLE 7

In this Example, a precursor of alkyd core polymer was synthesized with primary and secondary hydroxy polyols. To a flask equipped with a water receiver were added 240 parts of pentaerythritol, 400 parts of hydrogenated Bisphenol A, 300 parts of trimethyl pentanediol, 400 parts of Pamolyn 210, 400 parts of sunflower fatty acid, 620 parts of isophthalic acid and 0.5 parts of dibutyltin oxide. Under nitrogen blanketing, the temperature was heated to 230° C. while removing water. The process continued until the acid value dropped below 10.0. The reaction temperature was lowered to 180° C. and 90 parts of glycidyl neodecanoate was charged to the flask. The temperature was maintained at 180° C. for an additional one hour.

A precursor of shell polymer was obtained by the radical polymerization of ethylenically unsaturated monomers in the presence of fatty acid. To a reactor equipped with a cold-water condenser were added 556 parts of sunflower fatty acid, 477 parts of Pamolyn 210, 18 parts of di-t-butyl peroxide, 26 parts of styrene and 2 parts of hypophosphorous acid. The reactor was heated to 150° C. under nitrogen atmosphere. At 150° C., a mixture of 408 parts of styrene, 655 parts of isobutyl methacrylate, 398 parts of methacrylic acid and 66 parts of di-t-butyl peroxide were fed to the reactor over 4 hours. When the addition of the monomers was completed, 13 parts of di-t-butyl peroxide were charged to the reactor and the process continued at 150° C. for an additional 3 hours.

A core/shell alkyd dispersion having secondary hydroxy ester linkages was prepared from the precursor polymers. To a reactor were charged 290 parts of a precursor of core polymer product and 350 parts of a precursor of shell polymer product. The reactor was heated to 210° C. under nitrogen blanketing while collecting water. The process continued for 4.5 hours and the temperature was lowered to below 170° C. To the reactor were added 200 parts of n-butoxy ethanol and the temperature was lowered to below 100° C. While stirring, a mixture of 1000 parts of de-ionized water and 33 parts of aqueous ammonia were charged to the reactor. The resulting dispersion had an NV value of 32.1, a pH of 8.1, a viscosity of 93 Poise at 25° C., and an Acid Value of 21.1.

### EXAMPLE 8

An example of an air-drying paint made with a water dispersible composition according to embodiments of the present invention follows. To 373.83 grams of the resulting alkyd dispersion prepared in Example 7 were added 199.50 grams of Tipure® R-706 pigment available from DuPont, 99.75 grams of deionized water, and approximately 250 grams of glass beads. The mixture was transferred to a ball mill. The mixture was ground for one (1) hour on a paint shaker to obtain a 7+ Hegman Grind. The mixture was then removed from paint shaker. An additional 186.92 grams of the alkyd dispersion prepared in Example 7 were added to the mixture. A premix comprising 5.39 grams of Cobalt Hydrocure® II Drier (OMG), 0.90 grams of Activ® 8 (RT Vanderbilt) and 2.70 grams of Butyl Cellosolve was made and added to the mixture. To the mixture was also added 0.40 grams of aqueous Ammonia to raise the pH of the mixture to about 8.2-8.6. The Stormer viscosity of the mixture was checked to insure that it was within 60-70 KU. The mixture was then filtered through a 10-micron bag into a quart paint can.

The prepared air-drying paint showed excellent stability in pH value and viscosity even after 8 weeks of storage at about 120° F. The pH values and viscosity values of the air-drying paint over time are illustrated in Table I.

TABLE I

| Time | pH | Viscosity in KU |
|---|---|---|
| Initial | 8.5 | 62 |
| 1 week | 8.6 | 57 |
| 4 weeks | 8.6 | 54 |
| 8 weeks | 8.4 | 53 |

The air-drying paint made according to some embodiments of the present invention exhibited the following properties listed in Table II, which confirm that embodiments of the present invention may be used to prepare useful air-drying (ambient curing) paints:

TABLE II

| | |
|---|---|
| Volatiles Organic Compounds | 1.86 lbs/gal |
| Gardner Dry (Hard,) | 40 minutes |
| Zapon Dry (500 grams) | 1 hour 7 minutes |
| Gloss (60°/20°) | 83/55 |
| Pencil Hardness (1 week cure) | F |
| Sward Hardness (1D/3D/7D) | 30/38/38 |
| Regular Humidity Resistance | OK after 500 hours |

### EXAMPLE 9

In this Example, a precursor of alkyd core polymer was synthesized with primary and secondary hydroxy polyols. To a flask equipped with a packed column and water receiver were added 298 parts of pentaerythritol, 170 parts of trimethyl pentanediol, 621 parts of Hydrogenated Bisphenol A, 1190 parts of Pamolyn 210, 536 parts of isophthalic acid and 1.0 parts of dibutyltin oxide. Under nitrogen blanketing, the temperature was heated to 220° C. while removing water. The process continued until the acid value dropped below 10.0. The flask was cooled to 180° C. and 75 parts of glycidyl neodecanoate were charged to the flask. The process continued at 180° C. until the acid value dropped below 2.0.

A shell polymer formed with the core polymer by direct radical polymerization. To a reactor were added 500 parts of a precursor of core polymer product and 350 parts of n-butoxy ethanol. The reactor was heated to 150° C. under nitrogen blanketing. A mixture of 100 parts of methacrylic acid, 100 parts of styrene, 60 parts of isobutyl methacrylate and 15 parts of di-t-butyl peroxide were fed into the reactor over a period of 3 hours. After holding the temperature at 150° C. for 1 hour, the temperature was lowered to below 100° C. To the reactor were added 720 parts of de-ionized water and 70 parts of aqueous ammonia while stirring. The resulting dispersion had an NV value of 42.0, a pH of 8.9, a viscosity of 55 Poise at 25° C., and an Acid Value of 34.3.

### EXAMPLE 10—COMPARATIVE EXAMPLE

In a comparative Example, a precursor of alkyd core polymer was synthesized without secondary hydroxy polyol. To a flask equipped with a water receiver were added 687 parts of pentaerythritol, 1266 parts of toll oil fatty acid, 407 parts of linseed fatty acid, 537 parts of isophthalic acid and 0.4 parts of dibutyltin oxide. Under nitrogen blanketing, the temperature was heated to 250° C. while removing water. The process continued until the acid value dropped below 5.0. The flask was cooled to 140° C. and 900 parts of xylene was charged to the flask.

The comparative precursor of shell polymer was obtained by the radical polymerization of ethylenically unsaturated monomers in the presence of fatty acid. To a reactor equipped with a cold-water condenser were added 1099 parts of sunflower fatty acid, 715 parts of Pamolyn 210, 43.3 parts of di-t-butyl peroxide, 33 parts of styrene and 3.3 parts of hypophosphorous acid. The reactor was heated to 150° C. under nitrogen atmosphere. At 150° C., a mixture of 514 parts of styrene, 824 parts of isobutyl methacrylate, 789 parts of methacrylic acid and 83 parts of di-t-butyl peroxide were fed into the reactor over a period of 4 hours. When the addition of the monomers was complete, 16 parts of di-t-butyl peroxide were charged to the reactor over 30 minutes as a chaser. The process continued at 150° C. for additional 2 hours.

The comparative core/shell alkyd dispersion was prepared from the precursor polymers. To a reactor were charged 1010 parts of a precursor of core polymer product and 986 parts of a precursor of shell polymer product. The reactor was heated to 190° C. under nitrogen blanketing while collecting water and xylene. The process continued for 3 hours and the temperature was lowered to below 170° C. To the reactor were charged 262 parts of butoxy ethanol and the temperature was lowered to below 100° C. While stirring, a mixture of 1800 parts of de-ionized water and 80 parts of aqueous ammonia were charged to the reactor. The resulting dispersion had an NV value of 39.5, a pH of 7.9, a viscosity of 111 Poise at 25° C., and an Acid Value of 29.6.

The storage life of water dispersible polymer compositions may be impaired by the hydrolysis of ester linkages in the polymers of the water dispersible polymer composition. For example, ester linkages in a water-reducible alkyd of a water dispersible polymer composition may be broken by hydrolysis. The hydrolysis of an ester linkage of an alkyd generates one carboxylic group. The generation of the carboxylic group increases the acid value of the water dispersible polymer composition. Thus, as the ester linkages of water-reducible alkyds in a water dispersible polymer composition are broken by hydrolysis, the acid value of the water dispersible polymer composition increases. Using the readily measurable acid value, the progress of hydrolysis in a water dispersible polymer composition, and hence the stability of the composition, may be determined.

Samples of water dispersible polymer compositions were stored for various aging periods at a temperature of about 120° F. The shelf life of the Examples having core polymers with ester linkages formed from secondary or tertiary hydroxy groups according to some embodiments of the present invention were compared to the shelf life of a water dispersible polymer composition that did not have secondary or tertiary hydroxy linkages in the core polymer. The acid values of the water dispersible polymer compositions formed in Examples 1-7 were measured during storage over time. The acid values of comparative Example 10 were also measured during the same storage period. The results of the measurements are illustrated in Table III. Percentages appearing in parenthesis represent the percent increase in acid value from the initial acid value of the water dispersible polymer composition over time.

TABLE III

| Alkyd dispersion | Initial Acid | Acid | Acid | Acid |
|---|---|---|---|---|
| from | Value | Value at | Value at | Value at |
| Example No. | Before Heating | 6 weeks | 8 weeks | 12 weeks |
| Example 1 | 30.0 | | | 32.4 |
| | | | | (+8.0%) |
| Example 2 | 29.7 | | | 31.9 |
| | | | | (+7.4%) |
| Example 3 | 30.0 | 30.7 | 30.9 | 33.7 |
| | | (+2.3%) | (+3.0%) | (+12.3%) |
| Example 4 | 22.5 | 22.7 | | 24.6 |
| | | (+0.9%) | | (+9.3%) |
| Example 5 | 27.1 | 28.4 | | |
| | | (+4.8%) | | |
| Example 6 | 24.8 | 26.3 | 26.6 | 28.2 |
| | | (+6.0%) | (+7.3%) | (+13.7%) |
| Example 7 | 21.1 | | | 23.8 |
| | | | | (+12.8%) |
| Example 10 | 29.6 | 38.6 | 42.2 | Phase |
| (no secondary | | (+30.4%) | (+42.5%) | separated |
| hydroxy | | | | |
| ester linkages) | | | | |

The increase in the acid values of the product of comparative Example 10 is dramatic over time, culminating in phase separation at twelve weeks. In comparison, the increases in the acid values of the products of Examples 1-7, which were made according to embodiments of the present invention, are much smaller with no phase separations being observed. In fact, the amount of increase in the acid values of Examples 1-7 at the twelve week date are each much less than the acid value increase in the comparative Example 10 after just six weeks. This data demonstrates that the water dispersible polymer compositions according to embodiments of the present invention exhibit improved hydrolytic stability, which results in improved shelf lives for such products.

Having thus described certain preferred embodiments of the present invention, it is to be understood that the invention defined by the appended claims is not to be limited by particular details set forth in the above description as many apparent variations thereof are possible without departing from the spirit or scope thereof as hereinafter claimed.

What is claimed is:

1. A water dispersible polymer composition, comprising:
a core polymer including ester linkages formed from secondary or tertiary hydroxy groups; and
a shell polymer.

2. The water dispersible polymer composition of claim 1, wherein the core polymer is an alkyd polymer.

3. The water dispersible polymer composition of claim 1, wherein the core polymer is a polyester.

4. The water dispersible polymer composition of claim 1, wherein the core polymer ester linkages formed from secondary or tertiary hydroxy groups comprise at least five molar percent of the core polymer ester linkages.

5. The water dispersible polymer composition of claim 1, wherein the core polymer ester linkages formed from secondary or tertiary hydroxy groups comprise at least fifteen molar percent of the core polymer ester linkages.

6. The water dispersible polymer composition of claim 1, wherein the core polymer is formed from an alkyl substituted epoxy compound and at least one alkyl substituted cyclic carbonate compound.

7. The water dispersible polymer composition of claim 6, wherein the alkyl substituted epoxy compound is selected from the group consisting of glycidyl neodecanoate, diglycidyl ether of bisphenol A, diglycidyl ethers of bisphenol F, pentaerythriol polyglycidyl ether, sorbitol polyglycidyl ether, and propylene oxide.

8. The water dispersible polymer composition of claim 6, wherein the at least one alkyl substituted cyclic carbonate compound is selected from the group consisting of propylene carbonate and butylene carbonate.

9. The water dispersible polymer composition of claim 1, wherein the core polymer is formed from a compound selected from the group consisting of primary hydroxy-containing polyols, secondary hydroxy-containing polyols, polyacids, oils, and mono-functional acids.

10. The water dispersible polymer composition of claim 9, wherein said secondary hydroxy-containing polyols are selected from the group consisting of 2,2,4-trimethyl-1,3-pentanediol, 2,2′-bis(4-hydroxycyclohexy) propane, propylene glycol, dipropylene glycol, glycerol, and sorbitol.

11. The water dispersible polymer composition of claim 9, wherein said primary hydroxy-containing polyols are selected from the group consisting of trimethylol propane, pentaerythritol, di-pentaerythritol, trimethylol ethane, neopentyl glycol, ethylene glycol, 1,4-butanediol, 1,6-hexanediol, 1,4-cyclohexl dimethanol, diethylene glycol, triethylene glycol, and 2-methyl 1,3-propanediol.

12. The water dispersible polymer composition of claim 9, wherein said polyacids are selected from the group consisting of isophthalic acid, terephthalic acid, trimellitic anhydride, adipic acid, 1,4-cyclohexyl dicarboxylic acid, succinic anhydride, maleic acid, fumaric acid, succinic acid, azaleic acid, sebacic acid, methyl succinic anhydride, dodecenyl succinic anhydride, tetrahydrophthalic anhydride, hexahydrophthalic anhydride, and phthalic anhydride.

13. The water dispersible polymer composition of claim 9, wherein said mono-functional acids are selected from the group consisting of sunflower fatty acid, toll oil fatty acid, linseed oil fatty acid, safflower oil fatty acid, dehydrated castor oil fatty acid, soybean oil fatty acid and benzoic acid.

14. The water dispersible polymer composition of claim 9, wherein said oils are selected from the group consisting of sunflower oil, toll oil, linseed oil, safflower oil, dehydrated castor oil, and soybean oil.

15. The water dispersible polymer composition of claim 1, wherein the shell polymer is formed by radical polymerization of at least one ethylenically unsaturated monomer and (meth)acrylic acid in the presence of unsaturated fatty acids.

16. The water dispersible polymer composition of claim 15, wherein the at least one ethylenically unsaturated monomer is selected from the group consisting of styrene, vinyl toluene, methyl methacrylate, hydroxy ethyl acrylate, hydroxy ethyl methacrylate, hydroxy propyl acrylate, hydroxy propyl methacrylate, isobornyl methacrylate, n-butyl methacrylate, isobutyl methacrylate, n-butyl acrylate, and 2-ethyl hexyl (meth)acrylate.

17. The water dispersible polymer composition of claim 15, wherein the unsaturated fatty acids are selected from the group consisting of sunflower fatty acid, toll oil fatty acid, linseed oil fatty acid, safflower oil fatty acid, dehydrated castor oil fatty acid, and soybean oil fatty acid.

18. The water dispersible polymer composition of claim 1, wherein the core polymer and the shell polymer are bonded together.

19. The water dispersible polymer composition of claim 18, wherein the bond between the core polymer and the shell polymer is the result of a condensation reaction.

20. The water dispersible polymer composition of claim 1, wherein the shell polymer is formed by direct radical polymerization of at least one ethylenically unsaturated monomer and (meth)acrylic acid in the presence of the core polymer.

21. A water dispersible polymer composition, comprising:
a core polymer including ester linkages formed from secondary or tertiary hydroxy groups, wherein said core polymer is at least 10 weight percent of the water dispersible polymer composition; and
a shell polymer formed by radical polymerization of at least one ethylenically unsaturated monomer and (meth)acrylic acid in the presence of unsaturated fatty acids.

22. The water dispersible polymer composition of claim 21, wherein said shell polymer comprises at least 10 weight percent of the water dispersible polymer composition.

23. The water dispersible polymer composition of claim 21, further comprising at least one additive selected from the group consisting of thinners, neutralizers, pigments, and water.

24. The water dispersible polymer composition of claim 21, wherein said shell polymer comprises at most 90 weight percent of the unsaturated fatty acids.

25. The water dispersible polymer composition of claim 21, wherein said core polymer comprises between about 10 and about 90 weight percent of the water dispersible polymer composition.

26. The water dispersible polymer composition of claim 21, further comprising at least one organic solvent in an amount between about 5 and about 30 weight percent of the water dispersible polymer composition.

27. A coating composition, comprising:
a core polymer including at least five molar percent of ester linkages formed from secondary or tertiary hydroxy groups; and
a shell polymer formed by radical polymerization of at least one ethylenically unsaturated monomer and (meth)acrylic acid in the presence of at least one unsaturated fatty acid.

28. The coating composition of claim 27, wherein the core polymer is an alkyd polymer.

29. The coating composition of claim 27, wherein the core polymer is a polyester.

30. The coating composition of claim 27, further comprising at least one pigment.

31. The coating composition of claim 27, further comprising at least one melamine crosslinker.

32. The coating composition of claim 27, further comprising at least one multi-functional isocyanate crosslinker.

33. The coating composition of claim 27, wherein the core polymer and the shell polymer are bonded by a condensation reaction.

34. An ink composition, comprising:
a core polymer including at least five molar percent of ester linkages formed from secondary or tertiary hydroxy groups; and
a shell polymer formed by radical polymerization of at least one ethylenically unsaturated monomer and (meth)acrylic acid in the presence of at least one unsaturated fatty acid.

35. A method of forming a water dispersible polymer composition, comprising mixing a core polymer having at least five molar percent of ester linkages formed from secondary or tertiary hydroxy groups with a shell polymer formed by radical polymerization of at least one ethylenically unsaturated monomer and (meth)acrylic acid in the presence of at least one unsaturated fatty acid.

36. The method of claim 35, wherein said shell polymer is formed by radical polymerization of at least one ethlenically unsaturated monomer and (meth)acrylic acid in the presence of at least one unsaturated fatty acid.

37. The method of claim 35, further comprising bonding the core polymer and the shell polymer by condensation reaction.

38. The method of claim 35, further comprising bonding the core polymer and the shell polymer by condensation reaction between a carboxy group in a fatty acid and a hydroxy group in the core polymer.

39. The method of claim 35, further comprising heating the mixture of the core polymer and the shell polymer to a temperature between about 180° C. and about 220° C.

40. A core/shell polymer composition with ester linkages, comprising a core/shell polymer composition wherein at least 5 molar percent of the ester linkages are secondary or tertiary ester linkages.

41. The core/shell polymer composition of claim 40, wherein the core/shell polymer is a core/shell alkyd.

42. The core/shell polymer composition of claim 40, wherein the core/shell polymer is a core/shell polyester.

43. The core/shell polymer composition of claim 40, further comprising at least one pigment.

44. A water dispersible polymer composition, comprising:
a core/shell polymer composition with ester linkages wherein at least 5 molar percent of the ester linkages are secondary or tertiary ester linkages; and
at least one pigment.
